(19) United States
(12) Patent Application Publication
(10) Pub. No.: US 2006/0035204 A1
(43) Pub. Date: Feb. 16, 2006

(54) Method of processing non-responsive data items

(76) Inventors: Wesley Everett LaMarche, Iowa City, IA (US); John W. Anderson, Iowa City, IA (US); Joel Thompson, Iowa, IA (US)

Correspondence Address: Merchant & Gould P.C., P.O. Box 2903, Minneapolis, MN, 55402-0903, US

(21) Appl. No.: 10/916,958

(22) Filed: Aug. 11, 2004

(51) Int. Cl. G09B 3/00

(52) U.S. Cl. 434/350

(57) ABSTRACT

A method of obtaining an evaluation of a data item from a human evaluator includes presenting a data item to a human evaluator, and receiving a response from the evaluator that includes an indication that a data item is non-responsive or responsive. An output determined by a computer analysis of the data item is referenced and the evaluator response is compared to the output of the computer analysis.

### BACKGROUND OF THE INVENTION

The analysis of test answer sheets and other data items may be conducted with the assistance of computer technology. For example, answers to closed-ended test questions such as multiple-choice questions can be obtained using an optical mark recognition (OMR) system. In one such system, a test taker records answers by marking specified areas on a form, e.g. in predefined “bubbles”, which correspond to multiple choice answers or true-false answers. The presence of a mark by a test taker, such as a filled-in bubble, can be read by a scanner. U.S. Pat. No. 6,741,738 to Taylor describes a method of optical mark recognition.

Open-ended questions may also be processed with the assistance of a computer system. An open-ended question typically allows a responder to formulate a response, as opposed to choosing from a menu of pre-selected choices. In one system, paper-format test answers are scanned and then presented to test scorers electronically. Other systems provide for electronically-generated test answers. Open-ended systems may also be used with applications other than tests, including surveys, questionnaires, and the like. Methods and systems for evaluating open-ended items are described the following patents, which are incorporated herein by reference in their entireties: U.S. Pat. Nos. 5,437,554, 5,709,551, 5,718,591, 5,690,497, 5,735,694, 5,716,213, 5,752,836, 5,672,060, 5,987,149, 6,256,399.

Improved methods for processing data items are needed.

### SUMMARY OF THE INVENTION

A method of obtaining an evaluation of a data item from a human evaluator includes presenting a data item to a human evaluator and receiving from the evaluator a response which indicates that a data item is non-responsive or responsive. If the response from the evaluator indicates that the data item is non-responsive, reference is made to an output determined by a computer analysis of the data item, which also indicates whether the data item is non-responsive. The evaluator response is compared to the output of the computer analysis. In one embodiment, the response from the evaluator comprises a score for the test item.

In an embodiment, a plurality of data items can be presented to a human evaluator, and data can be collected regarding the frequency with which the human evaluator identifies a responsive item as non-responsive, such that a human evaluator with a proclivity for identifying responsive data items as non-responsive can be identified.

In an embodiment, if the evaluator response conflicts with the output of the computer analysis, the data item is presented to a second human evaluator, and a response is received from the second human evaluator. In an embodiment, the second human evaluator is a supervisor. In an embodiment, the data item is analyzed before the data item is presented to a human evaluator. In an embodiment, the computer analysis of the data item occurs before the data item is presented to a human evaluator. In an embodiment, if the response from the evaluator indicates that the data item is responsive, the output determined by the computer analysis of the data item indicating whether the data item is non-responsive is referenced, and the evaluator response is compared to the output of the computer analysis.

In an embodiment, the computer analysis includes a binary response that indicates whether the data item is non-responsive or responsive, where an indication that the item is responsive means that the data item has some marking that merits further evaluation by a human.

In an embodiment, the computer analysis is configured to identify remnants of the scanning process and at least some instances of erasure marks as non-responsive. In an embodiment, the computer analysis is configured to identify as responsive an item which contains pixels that exhibit a degree of adjacency which exceeds a predetermined threshold. In an embodiment, pixels are assigned intensity values, and the computer analysis includes examining the degree to which similar pixel values are congregated together. In an embodiment, the computer analysis is performed on a bi-tone image and the pixel intensity values are assigned binary values. In an embodiment, the computer analysis includes examining the extent to which pixels that have similar values are located immediately next to each other in the image. In an embodiment, the computer analysis includes examining the pixels to identify contiguous lines of pixels that have similar pixel values. In an embodiment, the computer analysis includes performing a convolution algorithm to determine whether the data item is devoid of substantive content.

In an embodiment, receiving a response from the evaluator includes receiving a score for the data item or receiving an indication that the data item is non-responsive, wherein the receipt of a score indicates that the data item is not non-responsive.

In an embodiment, the human evaluator is compensated for evaluating a data item. The compensation can be determined according to a compensation scheme that provides a disincentive for incorrectly identifying a responsive item as non-responsive and a disincentive for incorrectly identifying a non-responsive item as responsive.

In an embodiment, the compensation scheme allows for compensation of an evaluator based upon the number of data items for which the evaluator prepares a response, and the compensation scheme provides reduced compensation if the evaluator incorrectly identifies a responsive item as non-responsive or incorrectly identifies a non-responsive item as responsive. In an embodiment, the compensation scheme is at least partially based upon evaluator reliability that is determined at least in part from the frequency with which the evaluator incorrectly identifies data items as responsive or non-responsive. In an embodiment, data items are presented to a plurality of evaluators, and data is collected that reflect the evaluators' frequency of incorrectly identifying data items as responsive or non-responsive. The collected data is used to determine a particular evaluator's relative reliability in identifying data items as responsive or non-responsive. A compensation scheme can reflect the particular evaluator's relative reliability to determine compensation.

In an embodiment, the data item includes a digital representation of a response to a query. The data item may, for example, include scanned image of a paper response to the query.

In another embodiment, in an environment configured to allow a human evaluator to review a data item, a method of identifying whether a data item is non-responsive includes receiving the data item on a computer system, executing on the computer system an algorithm that is configured to determine whether the data item is non-responsive, presenting the data item to a human evaluator, and receiving a response from the human evaluator that indicates whether the item is non-responsive. The data item may be a test item. If the algorithm and the response from the human evaluator both indicate that the data item is non-responsive, the data item is designated as non-responsive. The algorithm may include a convolution process wherein pixels are examined for adjacency. The data item may be a scanned image.

In an embodiment, the algorithm includes resizing the scanned image to a pre-determined percentage of the original image size, analyzing a selected pixel by assigning weights to pixels that are located near the selected pixel, and assigning a value to the selected pixel based upon the content of the nearby pixels and the weights assigned to the nearby pixels.

In an embodiment, the nearby pixels define a rectangular block. In an embodiment, the rectangular block is a square and the selected pixel is at the center of the square. In an embodiment, the nearby pixels are eight pixels defining a 3×3 square with the selected pixel at the center of the square.

In an embodiment, resizing the image includes resampling the image to approximately 10 to 15% of its original size. In an embodiment, the image is converted to a bi-level image prior to the pixel analysis.

In an embodiment, the method is adapted for use with a scanner having particular parameters. The method can, for example, be adapted for use with scanner having a particular resolution and/or a scanner that is capable of assigning a predetermined number of shades of gray to pixels in a scanned image. In an embodiment, the predetermined percentage to which the image is resized is determined based at least in part on the particular resolution of the scanner.

In an embodiment, the algorithm includes converting overlay pallet entries to white, resampling the data item to a predetermined percentage of its original size, converting the resampled data item to a bi-level image, and examining pixels in the bi-level image.

In another embodiment, a method of processing data items includes receiving the data item on a computer system, executing on the computer system an algorithm that is configured to determine whether the data item is non-responsive, and presenting the data item to a human evaluator and receiving a response from the human evaluator. If the algorithm and the response from the human evaluator both indicate that the data item is non-responsive, the data item is designated as non-responsive. If the algorithm and the response from the human evaluator conflict, the data item is presented to a second evaluator, and a response is received from the second evaluator. If the response from the second evaluator indicates that the data item is non-responsive, the data item is designated as non-responsive. If the response from the second evaluator indicates that the data item is not non-responsive, the data item is presented to a third evaluator and a third response is received from the third evaluator.

In an embodiment, if the second evaluator agrees with the first evaluator or the algorithm, the data item is assigned the common response entered by the second evaluator and the algorithm or the first evaluator. In an embodiment, if the algorithm and the response from the human evaluator both indicate that the data item is not non-responsive, the data item is presented to a second evaluator and a second response is received from the second evaluator. In an embodiment, the method further includes capturing score agreement data from the algorithm and from evaluators for the purpose of subsequent reporting on the frequency of agreement.

In another embodiment, a method of processing data items includes receiving the data item on a computer system, executing on the computer system an algorithm that is configured to determine whether the data item is non-responsive, and presenting the non-responsive data items to a human evaluator and receiving a binary response from the human evaluator indicating whether or not the data item is non-responsive.

If the algorithm and the response from the human evaluator both indicate that the data item is non-responsive, the data item is designated as non-responsive. If the response from the human evaluator indicates that the data item is not non-responsive, the data item is sent to a scoring queue for evaluation by human evaluators as determined by pre-defined scoring rules.

In another embodiment, a method of processing data items includes receiving data items on a computer system, executing on the computer system an algorithm that is configured to determine whether the data items are non-responsive, presenting data item to a human evaluator and receiving a response from the human evaluator that indicates whether the data items are non-responsive, and gathering empirical data regarding whether the output of the algorithm is consistent with responses received from the evaluator. If the empirical data indicates that the algorithm is sufficiently accurate, the algorithm is used in lieu of a human evaluator to determine whether a data item is non-responsive. In an embodiment, the algorithm is determined to be sufficiently accurate when the comparative accuracy of the algorithm relative to known data for human evaluators exceeds a predetermined threshold. In an embodiment, the algorithm is determined to be sufficiently accurate when the empirical data indicates that the algorithm is more accurate than a human scorer.

### BRIEF DESCRIPTION OF THE DRAWINGS

FIG. 1 is a flow chart that shows a method of identifying a non-responsive data item.

FIG. 2 shows an example of a computer system that can be used to conduct analysis of a data item and/or present a data item to a human evaluator.

FIG. 3 shows an example of a network environment in which data items may be processed.

FIG. 4 shows a schematic of a method of analyzing data items that includes a blank recognition algorithm computer process.

FIG. 5 shows another schematic of a method of analyzing data items that includes a blank recognition algorithm computer process and presentation of data items to a blank-recognition evaluator.

FIG. 6 is a flow chart that illustrates a method of evaluating data items.

FIG. 7 is a flow chart that illustrates a method of determining whether a data item is non-responsive.

FIG. 8 is a flow chart that illustrates a method of pre-processing a data item.

FIG. 9 is a flow chart that illustrates a method of analyzing a data item to determine whether the data item is non-responsive.

FIG. 10 is a flow chart that illustrates a method of analyzing a selected pixel for adjacency of black pixels.

FIG. 11 is a flow chart that illustrates a method of analyzing pixels for adjacency by defining a block of weighted pixels.

FIG. 12 shows a group of pixels that may be examined for adjacency.

FIG. 13 shows a block of pixels and weight values assigned to the pixels.

FIGS. 14-A to 14-F show a variety of data items.

FIG. 15 is a flow chart that illustrates a method of processing data items where data items that are not determined to be non-responsive are sent to a scoring queue.

FIG. 16 is a flow chart that illustrates a method of processing data items where an algorithm is used in lieu of a human evaluator to determine responsiveness of data items if empirical data indicates that the algorithm is sufficiently accurate.

FIG. 17 is a flow chart that illustrates a method of processing data items where an evaluator's compensation depends on the evaluator's performance.

FIG. 18 is a flow chart that illustrates a method of processing data items where a conflict between a computer analysis and a human evaluator is resolved by a second evaluator.

### DETAILED DESCRIPTION OF THE PREFERRED EMBODIMENT

Computer analysis of a data item can be employed to determine whether the data item contains only non-responsive or irrelevant information. In the context discussed herein, a data item is a response by a human to some type of a query or prompt. Data items may be generated, for example, by a person who is responding to a test question, responding to a survey question, recording data on a form, or voting. Typically, most data items discussed in the context of the invention need to be viewed by a human evaluator in order to use the information in the data item, such as to assign a score to a test response. However, the use of computer analysis can be used to facilitate faster, more accurate, and less expensive assessment of data items.

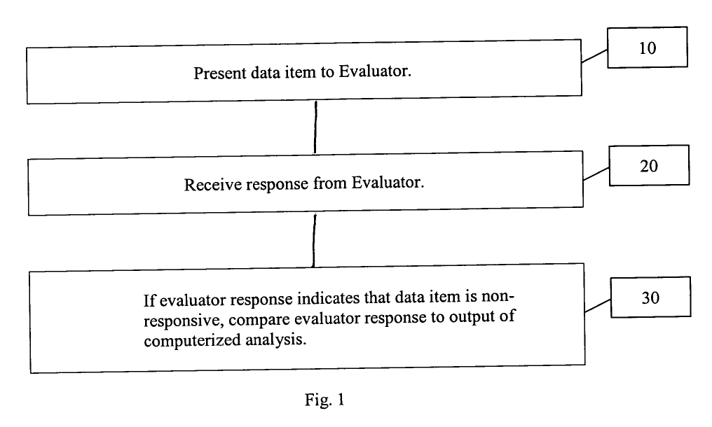

One embodiment of a method of processing a data item is shown in FIG. 1. Operations in the method can be performed by software modules. The various modules described herein can include sub-modules. Typically a module contains a plurality of submodules, which in turn can include further submodules. Present item module 10 is configured to display a data item to an evaluator. Receive response module 20 is configured to receive a response from the evaluator. If the evaluator response indicates that the data item is non-responsive, compare module 30 compares the evaluator response to the output of a computer analysis module (not shown in FIG. 1) that is configured to determine whether a data item is non-responsive.

In an embodiment, the parameters for treating a data item as non-responsive can be defined through an algorithm that supports the computer analysis module. In one embodiment, a non-responsive item can be defined as an item that is truly devoid of any marking. In another embodiment, an item that is not completely devoid of content may also be considered non-responsive. For example, it can be desirable to treat an item that does not include any substantive communicative information as non-responsive to avoid unnecessary human evaluation. In an embodiment, an item that contains information below a certain quantitative or qualitative threshold may be treated as non-responsive. Other embodiments are possible. As used herein, the term “blank” is used interchangeably with “non responsive,” i.e. blank refers not just to an item that contains no marking, but also to an item that contains some markings that do not constitute a meaningful response.

The parameters for identifying a data item as non-responsive can be tailored to the demands and idiosyncrasies of a particular context. Data items may be generated, for example, by processing information collected through surveys, organizational data-tracking, record-keeping, voting, or assessments. The parameters for identifying a data item may vary depending, for example, on the stakes of the context and the nature of the response. For a low-stakes environment, an algorithm that identifies more low-content data items as responsive may be desired, whereas in a high-stakes environment, it may be desirable to err on the side of designating borderline non-responsive items as responsive to ensure consideration by a human evaluator.

The identification of non-responsive data items can hold numerous benefits. First, the identification of non-responsive items can promote accurate evaluation (scoring). The accurate evaluation of items is given a very high priority in many circumstances, especially in the high-stakes testing context.

Computerized identification of non-responsive items can enhance scoring accuracy by allowing for identification of incorrect scores. For example, if a non-responsive item is improperly given a score for a substantive response, computerized identification of the item as non-responsive allows for identification of the incorrect score, thereby avoiding an inaccurate test score. Misidentification of non-responsive items can also be detrimental to a test taker who submits a non-responsive item: A test taker may, for example, strategically elect not to provide a response, i.e., to leave an answer non-responsive. In a test where a wrong answer is penalized more than no answer—for example in test where zero points are given for a non-responsive answer and points are deducted for a wrong answer, the test taker may strategically decide not to answer. The incorrect identification of a non-responsive item as a wrong substantive answer could thus be detrimental to the test taker.

Identifying non-responsive items with a computer process can also make the evaluation process quicker and/or more efficient. For example, computerized identification can allow for reduction in the number of evaluators who are presented with a data item, or can even eliminate the necessity of human evaluation of non-responsive items altogether. Computerized identification of non-responsive items can also be used as a quality check to confirm the accuracy of an evaluator.

In one embodiment, a computer system is configured to identify non-responsive data items by examining pixels for adjacency. Examining pixels for adjacency involves applying a filter or other operation to the image to examine the degree to which pixel values are congregated together, which suggests a substantive written answer. In a bi-tone image, for example, examining for adjacency refers to examining the degree to which black pixels are grouped together, as opposed to being dispersed or randomly distributed. In an embodiment, a computer analysis looks for pixels that are immediately next to each other, which reflects the movement of a writing implement. In an embodiment, an algorithm examines the pixels to identify contiguous lines of pixels.

In other embodiments, other types of analysis may be performed on marks made by a test taker (or other responder) to assess whether the marks make up a substantive answer or not. For example, for a test question that requires an essay answer, a computer analysis may determine that the test taker's answer does not contain enough information to formulate a response. In this context, where a response contains only one or two words, the response can be deemed too brief to constitute an essay answer, and thus be deemed non-responsive.

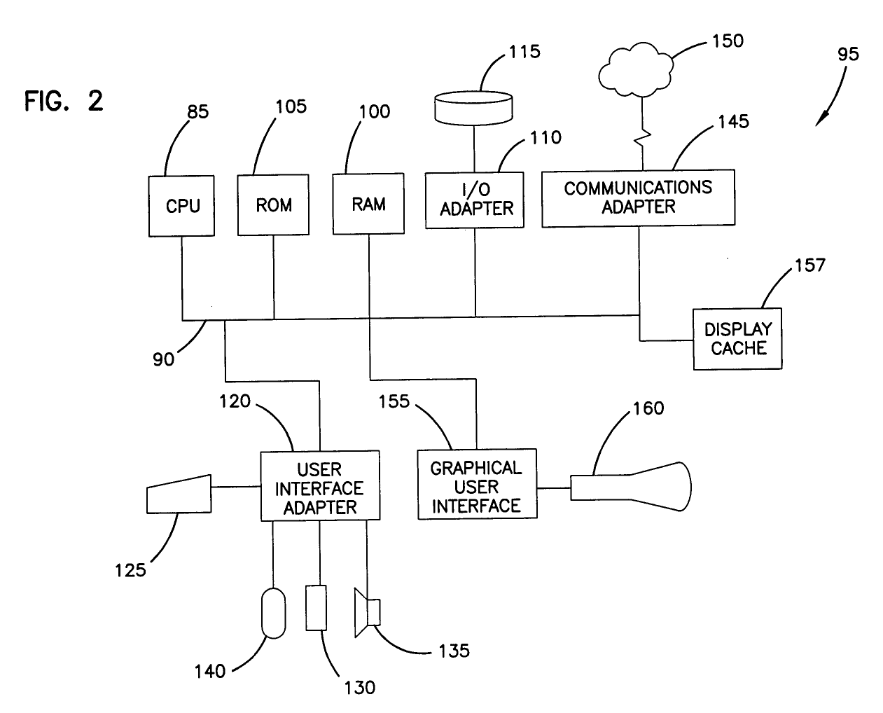

Turning now to FIG. 2, an example of a terminal 95 at which a human evaluator can be presented with data items is shown. The preferred hardware configuration includes a central processing unit 85, such as a microprocessor, and a number of other units interconnected by, for example, a system bus 90. The components of the terminal 95 may be contained within a single unit or spread out over one or more interconnected computers or computer systems. The evaluation terminal used to present data items to evaluators typically also includes a Random Access Memory (RAM) 100, Read Only Memory (ROM) 105, and an I/O adapter 110 for connecting peripheral devices such as disk storage units 115 to the bus 90. A user interface adapter 120 for connecting several input devices is also included. Examples of possible input devices electronically coupled to the user interface adapter 120 include a keyboard 125, a mouse 130, a speaker 135, a microphone 140, and/or other user interface devices such as a touch screen or voice interface (not shown). A communication adapter 145 is included for connecting the user terminal to a communication network link 150. A graphical user interface 155 is also coupled to the system bus 90 and provides the connection to a display device 160. It will be apparent to those in the art that the mouse 130 may be a typical mouse as known in the industry, or another input device such as a trackball, light pen, digital pen or the like. A display cache 157 may also be part of the user terminal. The display cache is shown in FIG. 2 as connected to the system bus 90, but may reside many other places within the user terminal.

Presentation of data items to evaluators may occur in a network environment. In a client/server system, each user is provided with a user terminal that may be linked to a modem, communication lines, network lines, a central processor, and databases. A WINDOWS 2000 server, for example, may be used with this system. Other server platforms, such as WINDOWS NT, UNIX, or LINUX server, may also be used. The user terminal provides the user with a way to view data items stored on the server. The user terminal also provides a way to input evaluations of data items. The evaluations may be electronically transmitted to the central server.

The network software operating system may be integrated into the workstation operating system, for example in a WINDOWS 2000 environment. The network operating system may have an integrated Internet browser, such as INTERNET EXPLORER. In the alternative, the network can include a separate resident operating system.

Several methods have been used to store data items and deliver data items to an evaluator at a workstation. For example, data items may be transferred to each workstation on a portable medium, such as a CD or DVD. Preferably, however, data items are stored on a central server and delivered over a network to a client workstation attached to the network. Content may also be delivered over the Internet, over optical data lines, by wireless transmission or by other transmission techniques.

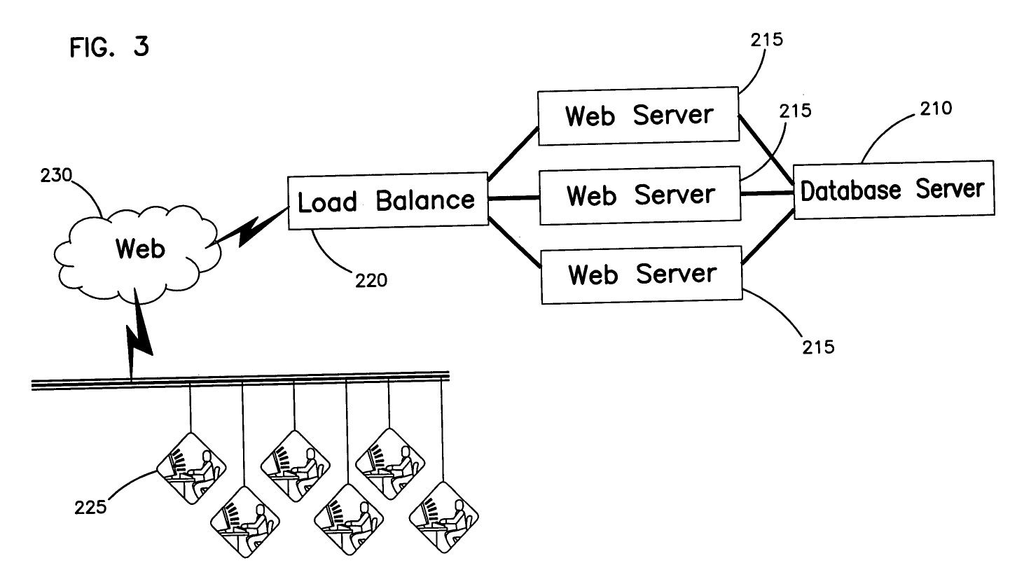

An example of an Internet delivery system is shown in FIG. 3. Data items are initially stored on a database server 210. A hardware or software load balance system 220 manages data transfer from the web server 215 to a workstation 225 connected to the Internet, for example through the World Wide Web 230. The load balance device allows the system to be scaled up by using multiple web servers to meet load demands.

In one embodiment, a data item is both analyzed by a computer and presented to a human evaluator for review. The computer outputs a responsive/non-responsive indicator. The human evaluator also determines whether or not the data item is non-responsive. If both the computer analysis and the human evaluator indicate that the data item is non-responsive, the item is accepted to be non-responsive. In some instances, the computer analysis and the human evaluator may produce conflicting results, e.g. the computer analysis may indicate that a data item is non-responsive but the human evaluator indicates that it is responsive, or vice-versa. In this instance, a resolution procedure may be performed to resolve the conflict. In one embodiment, the data item is presented to a second human evaluator, who preferably is a supervisory person, for resolution of the conflict. A response is received from the second human evaluator that indicates that the data item is responsive or non-responsive. In one embodiment, the response from the second human evaluator is determinative in deciding whether the data item is non-responsive. In another embodiment, the data item may be subject to more intensive human or computer analysis after a conflict arises.

In one embodiment, a computer analysis is performed on each data item before the data item is presented to an evaluator. In paper-based systems, the computer analysis may occur in conjunction with a scanning process, or after the scanning process. Alternatively, a computer analysis may be triggered when an evaluator marks an item as non-responsive.

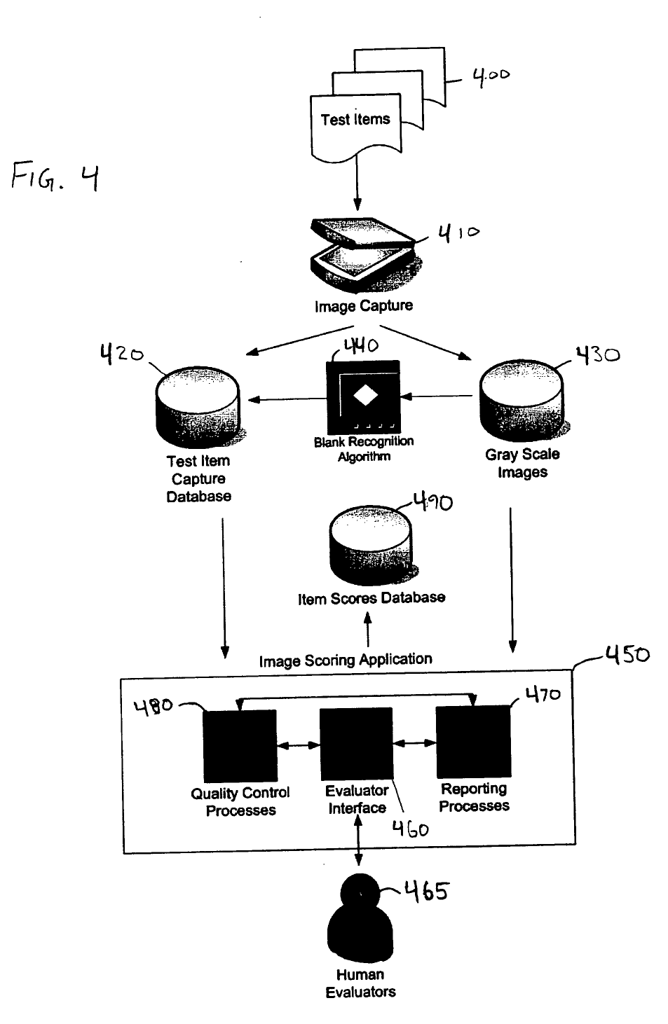

FIG. 4 shows a schematic of a data item processing method where the item is analyzed both by a computer and by an evaluator. Data items such as test items 400 are processed to capture images of the data items. Image capture process 410 can involve an optical scan of paper items or electronic capture, for example in the case where a test is administered through a computer. Typical dimensions for scanned paper images are 7.5×10 inches, 7.5×5 inches, or 7.5×3 inches, but other dimensions are possible.

The captured images are sent to a database 420. The images are preferably captured in gray scale 430, but could alternatively be captured in color or bi-tone. A blank recognition algorithm 440 determines whether the images are blank. In one embodiment, the images are converted to bi-tone before being processed by the blank recognition algorithm. In another embodiment, a blank recognition algorithm is performed on gray scale images. The algorithm preferably is configured not merely to determine whether an item is completely empty, but rather to determine whether an item that may contain some content can be considered blank because the content is so sparse or random that the content does not constitute a response. An indication of whether the item is blank is stored in the capture database (or another database) for future reference.

Returning to FIG. 4, images of data items are conveyed to an image scoring application 450. In one embodiment, both bi-level and gray scale images 430 are available to the image scoring application: an evaluator can first be presented with the bi-tone image, which takes less bandwidth to transfer. If the bi-level image provides insufficient clarity, the gray scale image can be presented. Alternatively, only one set of images may be available.

The image scoring application contains an evaluator interface module 460, a reporting module 470, and a quality control module 480, which can each contain sub-modules. Other modules may also be provided. The evaluator interface module 460 is configured to display a data item to a human evaluator 465. The application 450 is configured to receive an evaluative response, such as a test item score, from the human evaluator through the interface module 460 or (through another module). The evaluator response is stored in a database 490. While the database 420 and 490 are shown as separate in FIG. 4, it is understood that databases can be combined as desired for a particular application and environment.

The quality control module 480 is configured to track the performance of the human evaluator and recommend corrective action if necessary. Quality control methods are described in U.S. Pat. No. 5,735,694, which is incorporated herein by reference. Reporting module 470 is configured to provide a report on the evaluator's performance in evaluating data items. Statistics which can be tracked and reported include average speed at which data items are evaluated, the total number of items which the evaluator has processed, the number of times the score (or other evaluative response) assigned by the evaluator has been reversed or overruled by a supervisor or other corrective process, inter-evaluator reliability (the evaluator's tendency to assign the same evaluative response as other evaluators for the same data item), and percentages that reflect these quantities.

These quality control methods can also be used to track data that shows how the computer algorithm is performing. For example, the frequency and percentage of incidents where the computer output conflicts with the evaluative result provided by the human can be tracked. Tracking and analyzing this data allows for determination of whether the computer algorithm can be used without human confirmation.

In one embodiment, all data items are subject to an initial human analysis and a computer analysis to determine whether they are non-responsive. Where a conflict arises between the human and computer analysis, an item can be subject to further computer analysis, further human evaluation, or both. This can allow for rapid processing of items during the initial non-responsiveness determination with a computer analysis that uses a relatively rapid algorithm that consumes only a moderate amount of computer resources. In one embodiment, a second, more resource-intensive process can be performed if a conflict arises about the responsiveness of the item between the initial computer analysis and the initial human analysis.

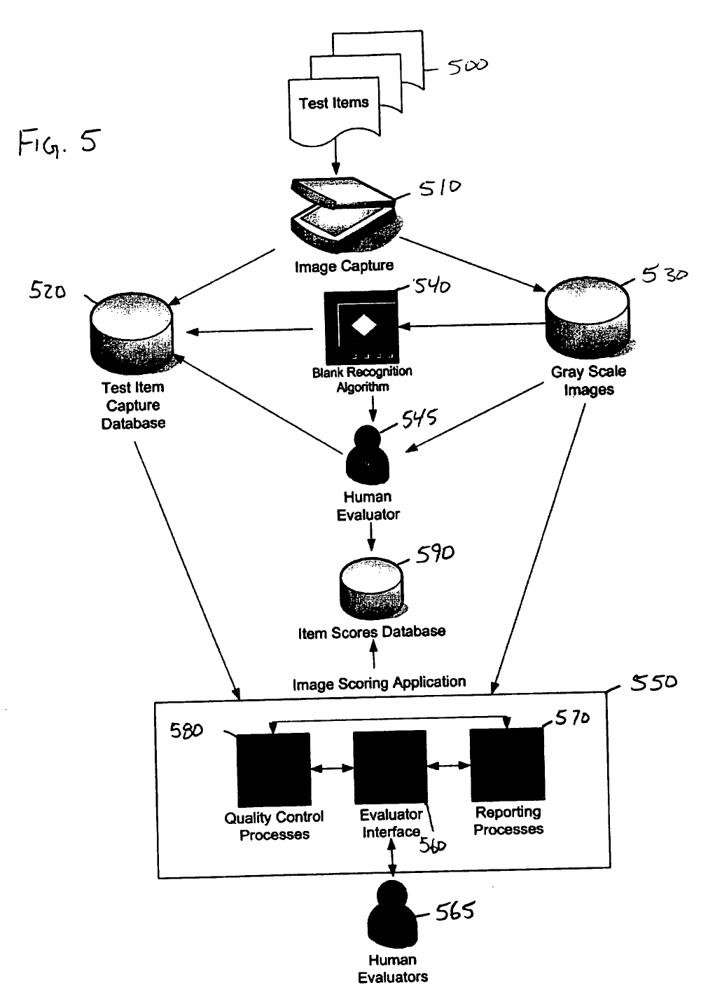

FIG. 5 illustrates an embodiment of a data item processing method where a designated human evaluator 545 provides an evaluation of whether an item is blank before the item is presented to a substantive evaluator 565. Test items 500 (or other types of data items) are put through an image capture process 510 and sent to a database 520. The images are preferably captured in gray scale 530. After optional preprocessing, the images are subject to a blank recognition computer algorithm 540 that determines whether the images are blank. In this context, “blank” is intended to refer to items that do not constitute a substantive response. (Blank does not necessarily mean completely empty, although a blank item may be completely empty.) The images are also presented to a human evaluator who determines whether items are blank. In one embodiment, if the responsiveness evaluator determines that the item is not blank, the evaluator may assign a score or other evaluative response. Alternatively, the evaluator may merely make a blank/non-blank determination.

If the algorithm and the evaluator agree that an item is blank, this information and/or a corresponding score or value are conveyed to database 590. If the algorithm and evaluator conflict, the item is sent to the image scoring application and presented to a substantive evaluator who decides whether the item is blank.

Images of data items are conveyed to an image scoring application 550 that preferably includes an evaluator interface module 560, a reporting module 570, and a quality control module 580.

Items are presented to a substantive evaluator 565 via the evaluator interface module 560 and evaluative responses are received through the interface module or another module. The evaluator response is stored in a database 590. Items that were definitively determined to be blank are not submitted to substantive evaluators.

In one embodiment, a computer analysis is integrated into a redundant evaluation system. In a redundant system, data items are evaluated a predetermined number of times (e.g. each item is evaluated twice). For illustration purposes, a test-based system that uses redundant scoring will be discussed, although the same techniques apply in non-test environments. In some embodiments, redundant scoring can improve scoring accuracy. Redundant scoring also allows for monitoring of scorer performance through statistical analysis. For example, redundant scoring allows for tracking of inter-scorer reliability. Where the scores assigned by a scorer reflect a high degree of consistency with scores assigned by other scorers for the same items, the scorer is considered to have high inter-scorer reliability. Assuming a high quality population of scorers, high inter-scorer reliability suggests that the scorer is demonstrating compliance with a scoring scheme. A scorer who has low inter-scorer reliability, i.e. who demonstrates a tendency to assign a score that deviates from the score assigned by another scorer for the same item, can be identified statistically. A low-performing scorer can then be alerted to the need for corrective action, retrained, dismissed, or otherwise handled.

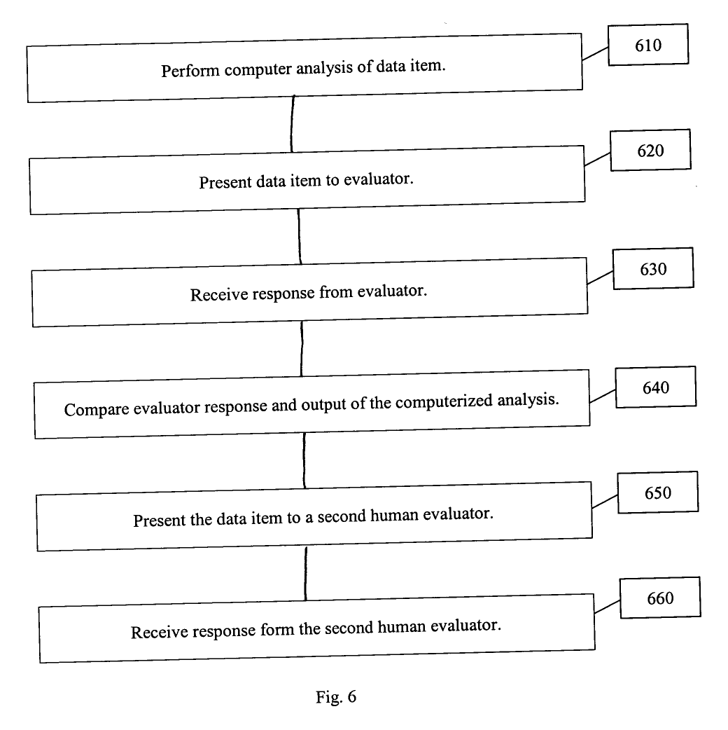

Referring now to FIG. 6, a method of evaluating data items is illustrated. Computer item analysis module 610 analyzes a data item to assess whether the item is non-responsive. Present module 620 presents a data item to a human evaluator. Receive response module 630 receives an evaluative response from an evaluator. Compare module 640 compares the response received from the evaluator to the output of the computer analysis module. Present module 650 presents the data item to a second human evaluator. Receive response module 660 receives an evaluative response form the second evaluator. The evaluator and second evaluator can be substantive evaluators. Alternatively, the evaluator and second evaluator can be non-responsiveness evaluators who determine whether the item is non-responsive but do not make a substantive evaluation. In the latter scenario, the evaluators may only be required to enter a binary response (blank/not-blank). Because a substantive evaluation is not required in this instance, the qualifications for being an evaluator can be lower. Taking some workload away from substantive scorers can offer a speed and cost advantage. For example, it may be easier to locate qualified scorers to make blank/non-blank determinations. Also, the compensation demanded by such scorers may be lower. In addition, items can be processed more quickly when a substantive evaluation is not required, which can lead to both speed and cost advantages.

The computer analysis of items to detect non-responsive items can involve preprocessing of items and execution of an algorithm that produces an output from which it can be decided whether the item is non-responsive.

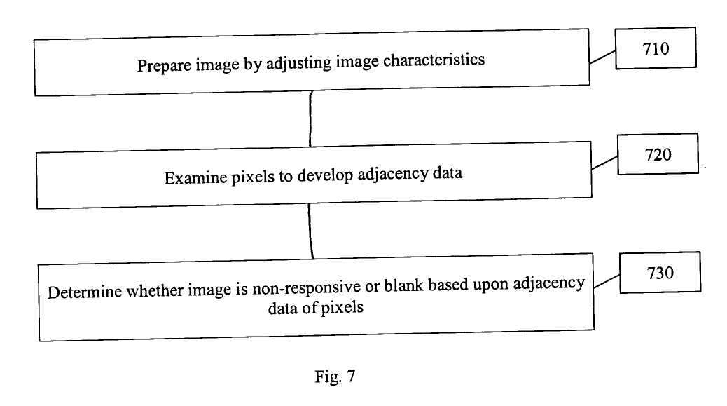

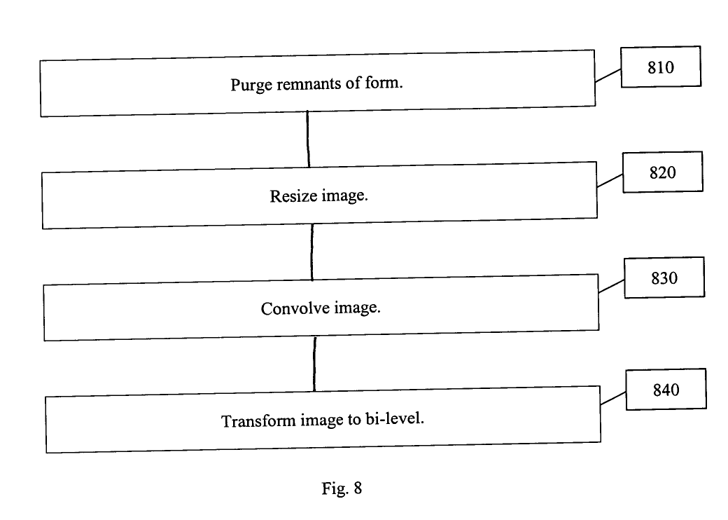

FIG. 7 illustrates a method of determining whether a data item is non-responsive. Prepare image module 710 adjusts characteristics of the image, such as image size or image type (e.g. bi-tone, gray scale, or color). Prepare image module 710 can contain sub-modules, such as the modules referenced in FIG. 8. Examine pixel module 720 examines pixels to develop adjacency data for the image. Determine responsiveness module 730 processes the adjacency data to determine whether the image is non-responsive.

In one embodiment, a series of preprocessing manipulations are performed on the data items. Preprocessing may include converting features that appear on a test form to white. For example, workspace boundaries that appear on a test form may be erased or otherwise modified to avoid a false-positive non-responsive identification based upon detection of features on the form rather than responsive markings.

Preprocessing may also include resampling the image to change the size, i.e. to reduce the number of bits in the image. Techniques for resampling and/or resizing an image are known to those skilled in the art. In an embodiment, the image is resized to obtain a target resolution. For a scanned image, for example, a target resolution can be measured in pixels per inch of the original paper item. In an embodiment, the image may be resized to a percentage of the original image size (in pixels) to reach the target resolution. For example, an image may be scanned at 120 dots per inch (dpi), and then resampled to 13 dots per inch (dpi). In an embodiment, images that are scanned at higher resolutions (e.g. 200, 240, or 300 dpi) are resampled to a smaller percentage of the original pixel resolution. For example, resampling a 300 dpi image to 13 dpi reduces the image to 4.3% of its original resolution and 4.3% of its original size in pixels. In another example, resampling an image with a resolution of 120 dpi to about 13 dpi reduces the image to about 11% of its original resolution. In an embodiment, resampling the image tends to emphasize contiguous series of dark pixels and de-emphasize pixels that are remote from other pixels. For example, image noise, small unintentional marks, or other small marks or dots may be eliminated by resampling while contiguous lines tend to be preserved in the resized image.

Preprocessing may also involve a convolution process. Generally, convolution is an algebraic matrix multiplication function. In an embodiment, a convolution process computes a weighted sum of input pixels that surround a selected target pixel. A convolution kernel defines which pixels are included in the operation and the weights assigned to those pixels. The convolution process computes an output value for a pixel by multiplying elements of a kernel by the values of pixels surrounding the selected source sample and summing the resulting products to produce the sample value of the selected source sample. This process is repeated for additional pixels in the image. In an embodiment, a border operation may be used to add an appropriate border to the source image to avoid shrinking the image boundaries.

In an embodiment, two matrices are defined: one matrix that contains data regarding whether particular pixels are white or black and a second matrix that contains weight values for the pixels. The two matrices are convolved: each element from one matrix is multiplied by respected element of the other matrix. The resulting elements are summed. The resulting information from the convolve function and summing may be used in the process of converting the image to bi-tone from gray scale.

Preprocessing may also include converting the image format, (e.g. from gray scale to bi-level, or from color to gray scale or bi-level). Various image conversion techniques are known to those skilled in the art. Where images are scanned in bi-tone, conversion may not be required. Other preprocessing operations are possible in addition to the preprocessing techniques described herein.

Preprocessing may be employed with scanned data items or with digitally received data items. If the images are scanned, the preprocessing operations can be adapted for use with a particular scanning system. For examples, preprocessing parameters may be selected based upon a particular resolution of a scanning system and the number of different shades of gray that the scanning system is capable of assigning to pixels in a scanned image. As described above, the resampling process may be adapted for a particular scanner resolution.

In one embodiment of a preprocessing system, images are scanned in gray scale, and overlay pallet entries are first converted to white. Then, the image is resampled to a predetermined percentage of its original size (in pixels) and resolution and converted from gray scale to bi-level. In a preferred embodiment for preprocessing scanned items, the image is resampled to 10 to 15% of its original size. In one embodiment, the image is resized to 11% of its original size. Next, the resampled image is convolved and then converted to bi-level (e.g. black and white or another bi-tone scheme). The pixels in the image are then examined.

FIG. 8 illustrates an embodiment of a method of pre-processing a data item. Purge form module 810 eliminates remnants of a form on which the data item was created, such as portions of a test form that define a space for providing a test answer. Resize module 820 resizes the image to a predetermined size. Convolve image module 830 convolves the image. Transform image module 840 transforms the image to bi-level.

In one embodiment, a plurality of pixel groups are examined during a computer analysis to determine whether a data item is responsive. A pixel group is defined by a selected pixel and other pixels that are nearby the selected pixel.

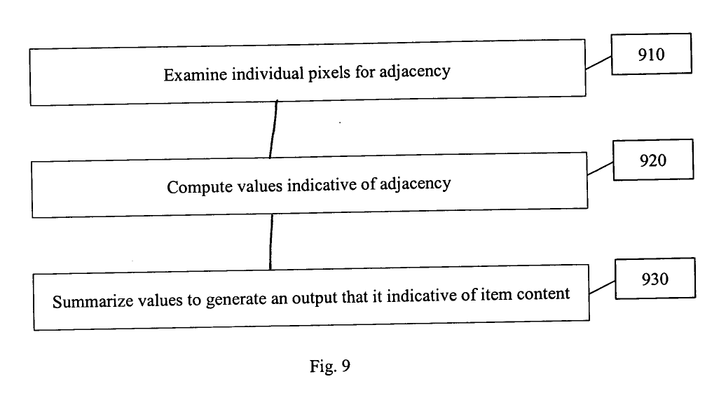

FIG. 9 illustrates a method of examining pixels to determine the content of an item. Examine pixels module 910 examines pixels for adjacency. Compute values module 920 computes adjacency values for pixels based on the examination of adjacency. Summarize data module 930 computes a summary value of the adjacency values to generate an output that is indicative of the item content. The output may be for example simply whether the item is non-responsive or, alternatively, the extent and nature of the item content, from which a responsive/non-responsive determination can be made, based upon predetermined thresholds.

The computer analysis process may involve a convolution process. In one embodiment, a convolution kernel includes two matrices: one matrix that contains data regarding pixel content and a second matrix that contains weight values for the pixels. The two matrices are convolved to produce resulting elements which are summed and used to determine whether the image contains responsive subject matter.

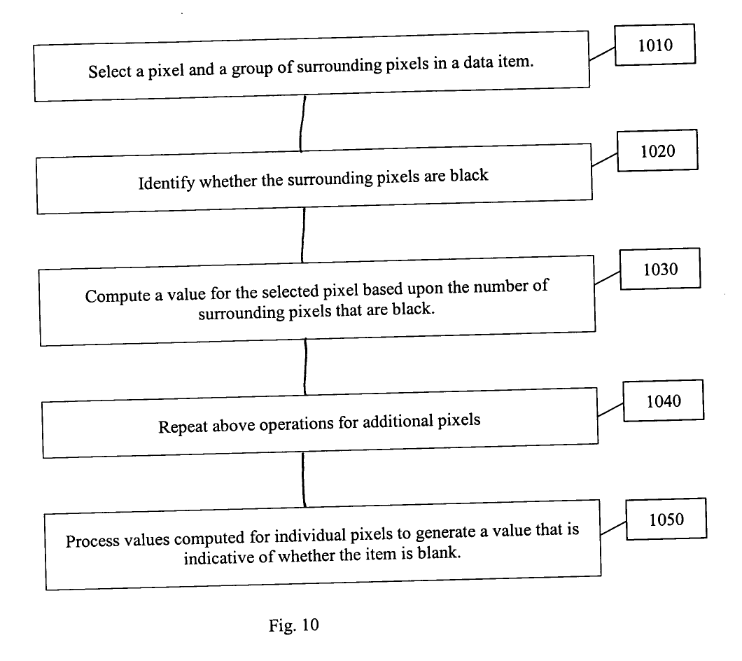

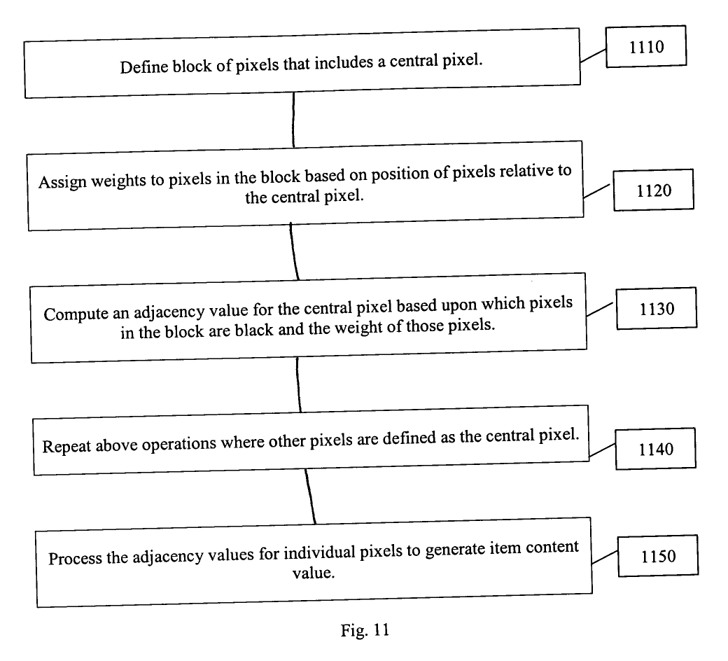

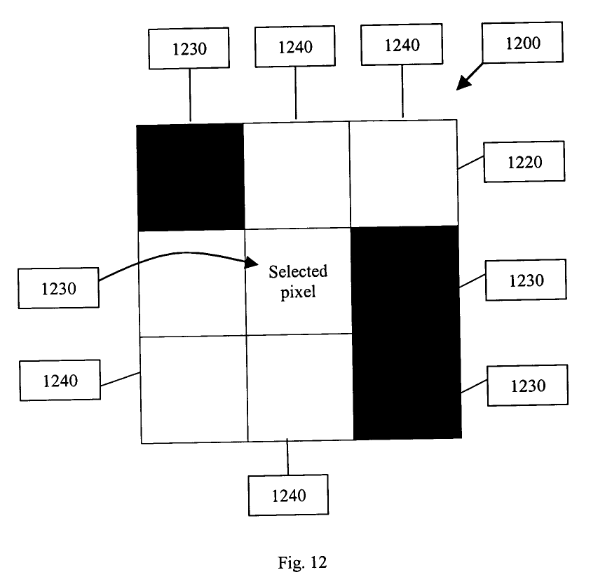

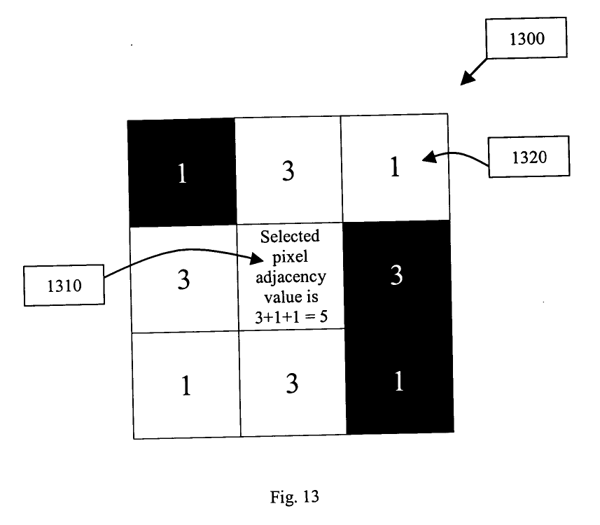

FIGS. 10 and 11 illustrate methods of examining pixels. Groups of pixels are shown in FIGS. 12 and 13.

FIG. 10 is a flow chart that illustrates a method of examining a selected pixel for adjacency. Select group module 1010 selects a pixel and a group of nearby pixels in a data item. Examine pixels module 1020 identifies whether the nearby pixels are black. Module 1020 could alternatively identify whether pixels are white or identify a pixel intensity value for a gray scale image. Compute pixel value module 1030 computes an output value for the selected pixel based upon the number of nearby pixels that are black. Alternatively, computer pixel value module can compute a value for the selected pixel based upon the intensity (shade of gray) of pixels that are near the selected pixel. Repeat module 1040 repeats the preceding operations 1010, 1020, 1030 for other selected pixels. In one embodiment, operations 1010, 1020, 1030 are performed for most or all of the pixels in the image. It should be noted that in some embodiments, it may not be possible to perform the operations on pixels at the edge of image. In this case, a border process may be executed. Generate image value module 1050 processes the values for the individual pixels to generate a value that is indicative of whether the item is responsive or non-responsive.

In one embodiment, the pixels in the group define a rectangular shape. In one embodiment, for example, the pixels in the group define a square. Other shapes, including non-rectangular shapes such as a diamond, could be used. The shape preferably defines a central pixel 1210, which is deemed a selected pixel for analysis of adjacency. FIG. 12 shows a rectangular block 1200 that contains white pixels 1240 and black pixels 1230. In a preferred embodiment, the pixel group consists of nine pixels that form a 3×3 rectangle, with the pixel at the center of the 3×3 rectangle being the selected pixel, as shown in FIG. 12. The pixels in the group are examined to identify which pixels surrounding the selected pixel are black. An adjacency value for the central pixel is computed based upon how many pixels in the group are black. (For a gray scale image, a weighted sum can be computed based upon the shades of gray of pixels that are near the selected pixel.) This process can be repeated for additional pixels so that an array of values is generated for the image. In a preferred embodiment, each possible 3×3 block of pixels is processed. In an embodiment, pixels at or near the edge of the image that do not fall within the center of a 3×3 block are not assigned an adjacency value. In another embodiment, a border pixel operation can be performed. For example, compensating measures can be taken to make up for the absence of pixels in the block. The compensating measure can include, for example, assigning the “missing” pixels to white, or multiplying by a fraction (e.g. 9/7 where two pixels are missing) to augment the adjacency value for the pixel. Other variations are possible.

The array of pixel values can be interpreted to assess whether or not the image is non-responsive. In an embodiment, a representative adjacency value for the image as a whole is computed. In one embodiment, the adjacency value for the image can be determined by summing the adjacency values for the selected pixels. In an embodiment, the result of the computer analysis is indicative of the presence of substantial contiguous lines of pixels.

In one embodiment, 3×3 blocks of pixels are examined to determine whether more than three pixels are black in the 3×3 cell. A tally is counted for the image, where the tally value is increased each time it is determined that a block of 3×3 pixels includes three or more black pixels.

FIG. 11 is a flow chart that illustrates a method of examining a selected pixel for adjacency that includes weighting of adjacent pixels. Define block module 1110 defines a block of pixels in the image, the block including a central pixel. Assign weight module 1120 assigns weights to pixels in the block based on the position of pixels relative to the central pixel. In an embodiment, modules 1110 and 1120 may be considered to define a convolution kernel. Compute adjacency module 1130 computes an adjacency value for the central pixel based upon which pixels in the block are black and the weight of the black pixels. In an embodiment, module 1130 executes a convolution operation. While pixels are described and shown as black and white for purposes of illustration and explanation, it is understood that the pixels are bi-level (bi-tone) and different colors or indicators could be used, and that gray scale or color processes are also possible. Repeat module 1140 repeats the three preceding operations 1110, 1120, 1130 for other pixels. Process values module 1150 processes the adjacency values of the individual pixels in the image to generate a content value for the image.

In an embodiment, pixels in the group 1300 of pixels surrounding the selected pixel 1310 are each assigned a weight 1320, as shown in FIG. 13. The adjacency value for the selected pixel can be computed through a convolution process that incorporates the weights of the pixels surrounding the selected pixel. For example, in the embodiment shown in FIG. 13, where the group of pixels is selected to be a 3×3 block with the selected pixel at the center, the pixels above, below, and to the side of the selected pixel are assigned a weight of 3, while the diagonally connected pixels are assigned a weight of 1.

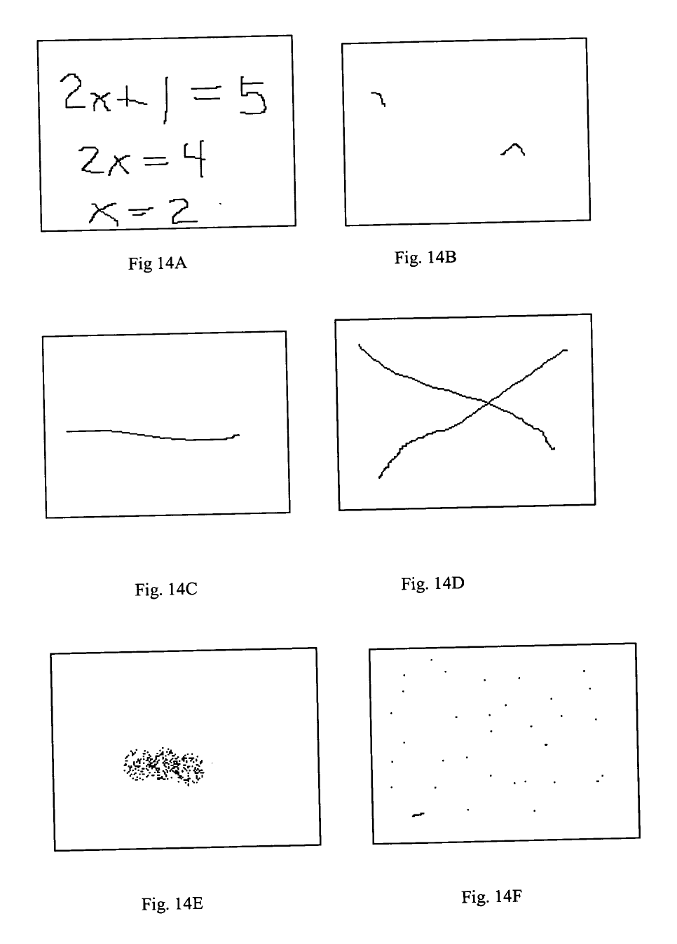

Referring now to the data items shown in FIGS. 14A-F, an assessment environment that includes a test taker who prepares a test answer that is scored by a test scorer will be described for illustrative purposes. A test taker is presented with a question and asked to provide an open-ended answer, which is scanned and saved as a data item. A variety of responses from the test taker are possible. The response may contain a substantive answer as shown in 14A. Where the test taker does not provide a responsive answer, the data item may be essentially empty, i.e. literally blank (not shown.) Alternatively, the data item may contain information that does not make up a substantive response as shown in FIGS. 14B-F. For example, the item may contain non-sensible information, such as a scribble, as shown in FIG. 14B. Or, the item may include a marking to indicate that a response will not be provided, such as a dash, slash, or an X, as shown in FIGS. 14C and 14D. In a paper-based test, the item may contain evidence of an erasure, such as where a test taker provided a response and then removed it, as illustrated in FIG. E. Where items are scanned, the item may include “residue” of the scanning process, such as dots or other marks that were not in the original, but that were added as the item was scanned, as shown in FIG. F. Such marks could include, for example, dirt or a scratch on a scanning surface or other contamination of scanning equipment.

In a preferred embodiment, a computer analysis is configured such that the class of items that are treated as “non-responsive” is broad enough to include data items that contain some information, but which information can be determined to be non-responsive. For example, in some contexts, it is desirable to identify as non-responsive features such as scribbles, remnants of the scanning process, and the other examples discussed above, to avoid presenting such items to a substantive scorer.

In one embodiment, a responsive item is defined to be an item that has some marking that merits further evaluation by a human, including an item that deserves a score, an illegible item, and a non-English item. An algorithm can be configured to sort out items that do not require human evaluation. In an embodiment, a computer interface can be configured to allow an evaluator to enter a variety of evaluative responses, including a numerical score, an indication that an item is blank or non-responsive, an indication that an item is illegible, an indication that an item is not in English, an indication that the item is off-topic, and others.

In an alternative embodiment, only completely empty data items are treated as non-responsive. This configuration may be desirable, for example, in a very high-stakes environment.

In an embodiment, a computer analysis of data items to identify non-responsive items can be integrated into a redundant evaluation by entering a computer-determined score (or non-responsive status) in lieu of one of the human scores. Returning again the illustrative discussion of scoring systems, test items can be received into a computer system and analyzed to detect non-responsive items. Items that are not identified as non-responsive are forwarded on to be redundantly scored, e.g. scored by at least two scorers. Where a scoring disagreement arises, a resolution process can for example involve a third supervisory scorer who definitively assigns a score to the item. For items that the computer analysis determines are non-responsive, the items can be presented to a single scorer to confirm that the item is non-responsive. The computer analysis may be treated as a “live” scorer for the purpose of statistical analysis of scorer accuracy and/or consistency. For example, inter-scorer reliability statistics can be obtained by comparing the score or status that a human scorer assigns to a non-responsive item against the computer analysis output.

In an embodiment, an algorithm can be tested against human scorers (and refined if necessary) until an acceptable confidence level in the algorithm is reached, at which point the algorithm alone may be used to identify non-responsive data items. For example, the percentage of time that the algorithm and human evaluator reach the same conclusion regarding whether the item is responsive can be tracked. Algorithm performance can also be tracked using known items that are added to an item population as a quality check. U.S. Pat. No. 5,672,060 discusses known or “anchor” items that are used to monitor scorer quality and is hereby incorporated by reference.

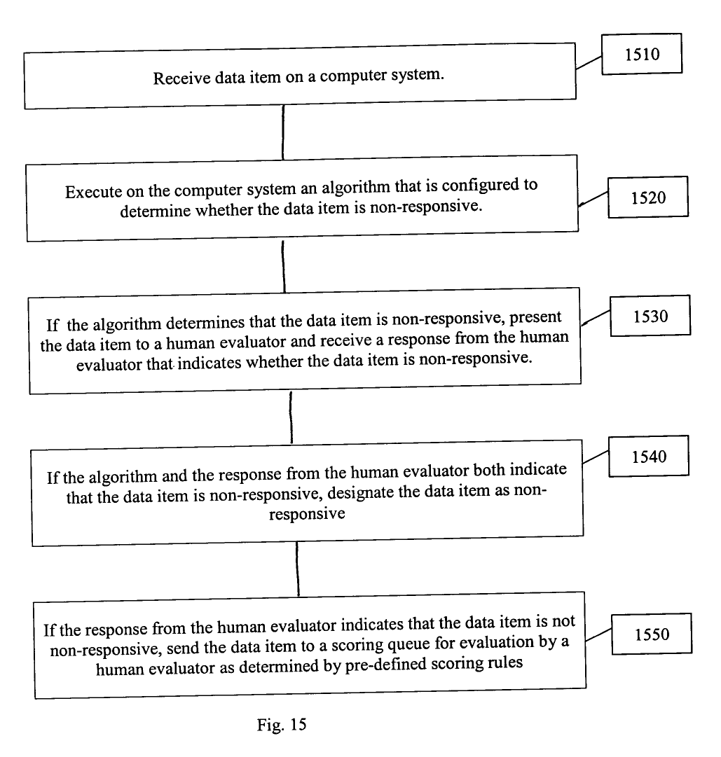

FIG. 15 illustrates a method of processing data items where items that are not determined to be non-responsive are sent to a scoring queue. Receive data item module 1510 receives a data item on a computer system. Execute algorithm module 1520 executes on the computer system an algorithm that is configured to determine whether the data item is non-responsive. Human interface module 1530 presents the data item to a human evaluator and receives a binary response from the human evaluator indicating whether or not the data item is non-responsive. Designate non-responsive module 1540 designates the data item as non-responsive if the algorithm and the response from the human evaluator both indicate that the data item is non-responsive. Send for scoring module 1560 sends the data item to a scoring queue for evaluation by a human evaluator as determined by pre-defined scoring rules if the response from the human evaluator indicates that the data item is not non-responsive.

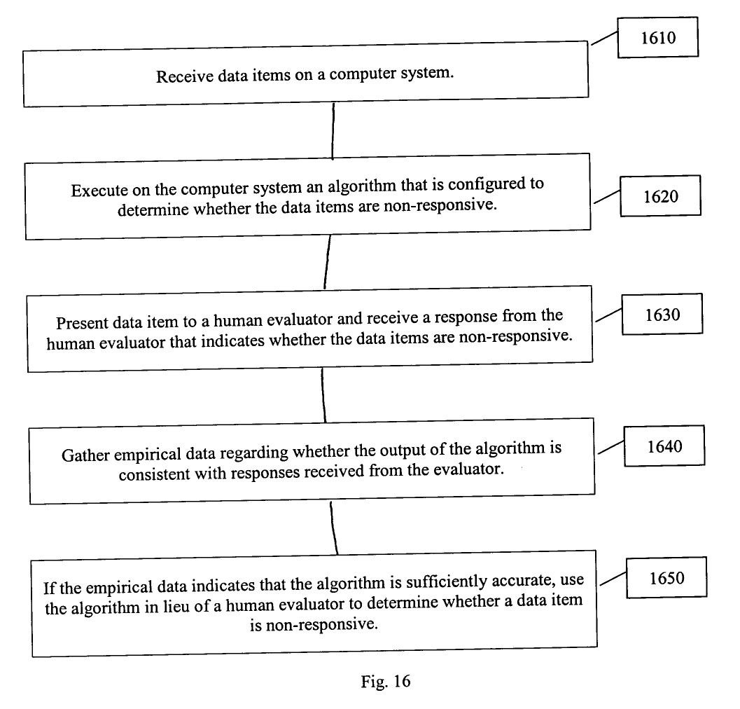

FIG. 16 illustrates a method of processing data items where empirical data on the algorithm performance is gathered. Receive data items module 1610 receives a data item on a computer system. Execute algorithm module 1620 executes on the computer system an algorithm that is configured to determine whether the data items are non-responsive. Human interface module 1630 presents the data items to a human evaluator and receives a response from the human evaluator indicating whether or not the data item is non-responsive. Gather data module 1640 gathers empirical data regarding whether the output of the algorithm is consistent with responses received from the evaluator. Exclusive algorithm deployment module 1650 determines whether the empirical data indicates that the algorithm is sufficiently accurate and suggests or initiates exclusive use of the algorithm in lieu of a human evaluator to determine whether a data item is non-responsive. In an embodiment, the algorithm is determined to be sufficiently accurate when the comparative accuracy of the algorithm relative to known data for human evaluators exceeds a predetermined threshold. In an embodiment, the algorithm is determined to be sufficiently accurate when the empirical data indicates that the algorithm is more accurate than a human scorer.

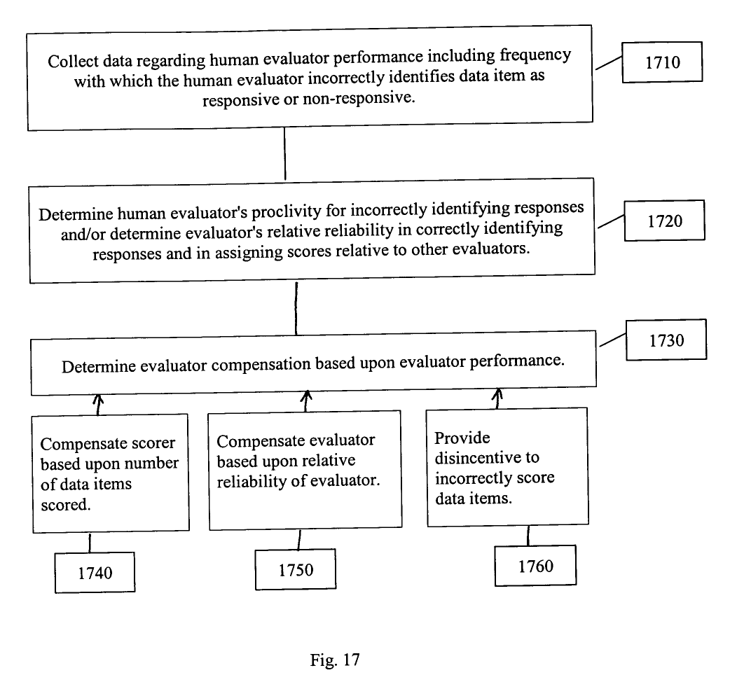

Referring now to FIG. 17, collect data module 1710 collects data which can be used in a compensation scheme. Determine evaluator performance module 1720 determines the evaluator performance in terms, for example, of the evaluator's relative reliability in scoring items or the evaluator's proclivity to misidentify items as responsive or non-responsive. Determine compensation module 1730 determine evaluator compensation based upon evaluator performance. Compensation can receive in put from number of items scored compensation module 1740 and/or relative reliability compensation module. Disincentive module 1760 can also influence compensation to discourage incorrect evaluation or scoring of data items.

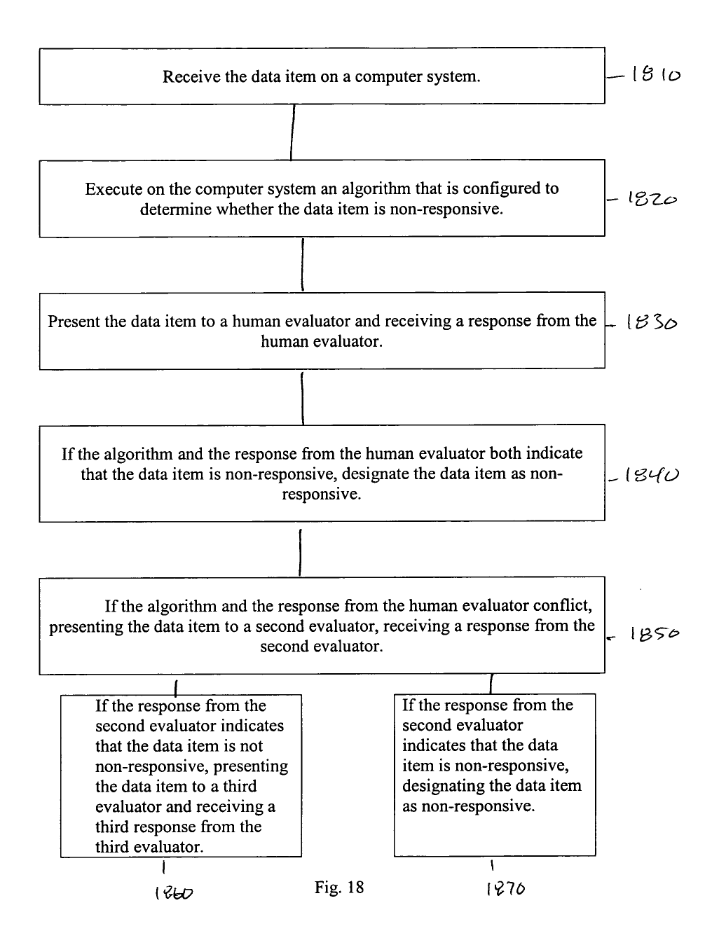

FIG. 18 illustrates an embodiment where an item is presented to a third evaluator if a first evaluator response conflicts with an algorithm output. Receive data module 1810 receives a data item. Execute algorithm module 1820 performs a computer analysis to determine whether the item is non-responsive. Present item module 1830 presents the item to a human evaluator and receives a response. Designate non-responsive module 1840 designates the item as non-responsive if algorithm and evaluator response do not conflict. Present to second evaluator module 1850 presents the data item to a second evaluator if the response from the first evaluator conflicts with the algorithm output. Designate non-responsive module 1870 designates the item as non-responsive if the second evaluator provides a response that the item is non-responsive. Present to third evaluator module 1860 presents the item to a third evaluator if the response from the second evaluator indicates that the item is not non-responsive. The third evaluator may for example be a substantive evaluator who provides a substantive evaluation, such as a numerical score. Score agreement data may be captured from the algorithm and from evaluators for the purpose of subsequent reporting on the frequency of agreement. In an embodiment, if the algorithm and the response from the first human evaluator both indicate that the data item is not non-responsive, the data item is presented to a second evaluator, who provides a substantive evaluation such as a score.

While the techniques of processing data items are described primarily in terms of methods, systems for implementing the techniques are also possible, using computer and/or scanner technology known to one skilled in the art. In addition, the computer modules described herein can be embodied on a computer-readable medium, such as a hard drive, a CD such as a CD-ROM, CD-R, CD-RW, a DVD medium, a flash drive, floppy disk, a memory chip, and other data storage devices.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of obtaining an evaluation of a data item from a human evaluator, the method comprising:
presenting a data item to a human evaluator;
receiving a response from the evaluator, the response comprising an indication that a data item is non-responsive or responsive;
if the response from the evaluator indicates that the data item is non-responsive, referencing an output determined by a computer analysis of the data item indicating whether the data item is non-responsive and comparing the evaluator response to the output of the computer analysis.

2. The method of claim 1 further comprising presenting a plurality of data items to a human evaluator and collecting data regarding the frequency with which the human evaluator identifies a responsive item as non-responsive, wherein a human evaluator with a proclivity for identifying responsive data items as non-responsive can be identified.

3. The method of claim 1 further comprising, if the evaluator response conflicts with the output of the computer analysis, presenting the data item to a second human evaluator and receiving a response from the second human evaluator.

4. The method of claim 3 wherein the second human evaluator is a supervisor.

5. The method of claim 1 wherein the computer analysis of the data item occurs before the data item is presented to a human evaluator.

6. The method of claim 5 further comprising if the response from the evaluator indicates that the data item is responsive, referencing the output determined by the computer analysis of the data item indicating whether the data item is non-responsive and comparing the evaluator response to the output of the computer analysis.

7. The method of claim 1 wherein the output of the computer analysis comprises a binary response indicating that the data item is non-responsive or responsive, where responsive indicates that the data item has some marking that merits further evaluation by a human.

8. The method of claim 7 wherein the computer analysis is configured to identify remnants of the scanning process and at least some instances of erasure marks as non-responsive.

9. The method of claim of claim 7 wherein the computer analysis is configured to identify as responsive an item which contains pixels that exhibit a degree of adjacency which exceeds a predetermined threshold.

10. The method of claim 9 wherein pixels are assigned intensity values, wherein the computer analysis comprises examining the degree to which similar pixel values are congregated together.

11. The method of claim 10 wherein the computer analysis is performed on a bi-tone image and the pixel intensity values are assigned binary values.

12. The method of claim 10 wherein the computer analysis comprises examining the extent to which pixels that have similar values are located immediately next to each other in the image.

13. The method of claim 10 wherein the computer analysis comprises examining the pixels to identify contiguous lines of pixels that have similar pixel values.

14. The method of claim 1 wherein the computer analysis comprises performing a convolution algorithm to determine whether the data item is devoid of substantive content.

15. The method of claim 1 wherein receiving a response from the evaluator may include receiving a score for the data item or receiving an indication that the data item is non-responsive, wherein the receipt of a score indicates that the data item is not non-responsive.

16. The method of claim 1 further comprising compensating the human evaluator for evaluating a data item, the compensation being determined according to a compensation scheme that provides a disincentive for incorrectly identifying a responsive item as non-responsive and a disincentive for incorrectly identifying a non-responsive item as responsive.

17. The method of claim 16 wherein the compensation scheme allows for compensation of an evaluator based upon the number of data items for which the evaluator prepares a response, the compensation scheme providing reduced compensation if the evaluator incorrectly identifies a responsive item as non-responsive or incorrectly identifies a non-responsive item as responsive.

18. The method of claim 16 wherein the compensation scheme is at least partially based upon evaluator reliability that is determined at least in part from the frequency with which the evaluator incorrectly identifies data items as responsive or non-responsive.

19. The method of claim 16 further comprising presenting data items to a plurality of evaluators, collecting data that reflect the evaluators' frequency of incorrectly identifying data items as responsive or non-responsive, and using the collected data to determine a particular evaluator's relative reliability in identifying data items as responsive or non-responsive, wherein the compensation scheme uses the particular evaluator's relative reliability to determine compensation.

20. The method of claim 1 wherein the data item comprises a test item and the response from the evaluator comprises a score for the test item.

21. The method of claim 1 wherein the data item comprises a digital representation of a response to a query.

22. The method of claim 21 wherein the data item comprises a scanned image of a paper response to the query.

23. In an environment configured to allow a human evaluator to review a data item, a method of identifying whether a data item is non-responsive:
receiving the data item on a computer system;
executing on the computer system an algorithm that is configured to determine whether the data item is non-responsive;
presenting the data item to a human evaluator and receiving a response from the human evaluator that indicates whether the item is non-responsive;
if the algorithm and the response from the human evaluator both indicate that the data item is non-responsive, designating the data item as non-responsive.

24. The method of claim 23 wherein the algorithm comprises a convolution process wherein pixels are examined for adjacency.

25. The method of claim 23 wherein the data item comprises a scanned image.

26. The method of claim 25 wherein the algorithm comprises:
a) resizing the scanned image to a pre-determined percentage of the original image size;
b) analyzing a selected pixel by assigning weights to pixels that are located near the selected pixel and assigning a value to the selected pixel based upon the content of the nearby pixels and the weights assigned to the nearby pixels;
c) repeating the operations of part (b) for additional selected pixels.

27. The method of claim 26 wherein the nearby pixels define a rectangular block.

28. The method of claim 27 wherein the rectangular block is a square and the selected pixel is at the center of the square.

29. The method of claim 27 wherein the nearby pixels are eight pixels defining a 3×3 square with the selected pixel at the center of the square.

30. The method of claim 26 wherein resizing the image comprises resampling the image to approximately 10 to 15% of its original size in pixels.

31. The method of claim 26 wherein the image is converted to a bi-level image prior to the pixel analysis.

32. The method of claim 26 wherein the method is adapted for use with a scanner having particular parameters.

33. The method of claim 32 wherein the method is adapted for use with scanner having a particular resolution.

34. The method of claim 32 wherein the method is adapted for use with a scanner that is capable of assigning a predetermined number of shades of gray to pixels in a scanned image.

35. The method of claim 34 wherein the predetermined percentage to which the image is resized is determined based at least in part on the particular resolution of the scanner.

36. The method of claim 23 wherein the algorithm comprises converting overlay pallet entries to white, resampling the data item to a predetermined percentage of its original size; converting the resampled data item to a bi-level image; and examining pixels in the bi-level image.

37. The method of claim 23 wherein the data item is a test item.

38. A method of processing data items comprising:
receiving the data item on a computer system;
executing on the computer system an algorithm that is configured to determine whether the data item is non-responsive;
presenting the data item to a human evaluator and receiving a response from the human evaluator;
if the algorithm and the response from the human evaluator both indicate that the data item is non-responsive, designating the data item as non-responsive;
if the algorithm and the response from the human evaluator conflict, presenting the data item to a second evaluator, receiving a response from the second evaluator, and performing one of the following:
if the response from the second evaluator indicates that the data item is non-responsive, designating the data item as non-responsive; or,
if the response from the second evaluator indicates that the data item is not non-responsive, presenting the data item to a third evaluator and receiving a third response from the third evaluator.

39. The method of claim 38, further comprising if the second evaluator agrees with the first evaluator or the algorithm, assigning the data item the common response entered by the second evaluator and the algorithm or the first evaluator.

40. The method of claim 38, further comprising if the algorithm and the response from the human evaluator both indicate that the data item is not non-responsive, presenting the data item to a second evaluator and receiving a second response from the second evaluator.

41. The method of claim 38, further comprising capturing score agreement data from the algorithm and from evaluators for the purpose of subsequent reporting on the frequency of agreement.

42. A method of processing data items comprising:
receiving the data item on a computer system;
executing on the computer system an algorithm that is configured to determine whether the data item is non-responsive;
presenting the non-responsive data items to a human evaluator and receiving a binary response from the human evaluator indicating whether or not the data item is non-responsive;
if the algorithm and the response from the human evaluator both indicate that the data item is non-responsive, designating the data item as non-responsive;
if the response from the human evaluator indicates that the data item is not non-responsive, sending the data item to a scoring queue for evaluation by human evaluators as determined by pre-defined scoring rules.

43. A method of processing data items comprising:
receiving data items on a computer system;
executing on the computer system an algorithm that is configured to determine whether the data items are non-responsive;
presenting data item to a human evaluator and receiving a response from the human evaluator that indicates whether the data items are non-responsive;
gathering empirical data regarding whether the output of the algorithm is consistent with responses received from the evaluator;
if the empirical data indicates that the algorithm is sufficiently accurate, using the algorithm in lieu of a human evaluator to determine whether a data item is non-responsive.

44. The method of claim 43 wherein the algorithm is determined to be sufficiently accurate when the comparative accuracy of the algorithm relative to known data for human evaluators exceeds a predetermined threshold.

45. The method of claim 44 wherein the algorithm is determined to be sufficiently accurate when the empirical data indicates that the algorithm is more accurate than a human scorer.
